(19) United States
(12) Patent Application Publication
(10) Pub. No.: US 2025/0317816 A1
(43) Pub. Date: Oct. 9, 2025

(54) METHOD AND APPARATUS FOR INTER-CU LTM HANDOVER

(71) Applicant: Electronics and Telecommunications Research Institute, Daejeon (KR)

(72) Inventor: Sung Cheol Chang, Daejeon (KR)

(73) Assignee: Electronics and Telecommunications Research Institute, Daejeon (KR)

(21) Appl. No.: 19/171,953

(22) Filed: Apr. 7, 2025

(30) Foreign Application Priority Data
Apr. 5, 2024 (KR) 10-2024-0046977
May 10, 2024 (KR) 10-2024-0061593

(51) Int. Cl. H04W 36/00; H04W 74/0833

(52) U.S. Cl. CPC H04W 36/0077; H04W 36/0058; H04W 74/0833

(57) ABSTRACT

A method of a terminal may comprise: transmitting a measurement report to a serving cell corresponding to an identifier associated with a first centralized unit (CU); receiving information on at least one candidate cell including an identifier associated with a second CU from the serving cell through a radio resource control (RRC) reconfiguration message; transmitting a measurement report on the at least one candidate cell to the serving cell; receiving a cell switching command medium access control (MAC) control element (CE) for a target cell among the at least one candidate cell from the serving cell; performing a random access procedure for the target cell based on the cell switching command MAC CE; and completing a connection to the target cell.

### CROSS-REFERENCE TO RELATED APPLICATIONS

This application claims priority to Korean Patent Applications No. 10-2024-0046977, filed on Apr. 5, 2024, and No. 10-2024-0061593, filed on May 10, 2024, with the Korean Intellectual Property Office (KIPO), the entire contents of which are hereby incorporated by reference.

### BACKGROUND

### 1. Technical Field

The present disclosure relates to L1/L2-triggered mobility (LTM) handover, and more particularly, to a method and apparatus for inter-centralized unit (CU) LTM handover in a mobile communication system.

### 2. Related Art

In a mobile communication system, a base station connected to a network can provide a radio connection to a terminal moving within a predetermined coverage. The terminal can be bidirectionally connected to the network through a process of bidirectionally exchanging data with the connected base station. The moving terminal can maintain connection with the network by changing a connected base station in a handover scheme. The base station may play a role of proactively managing resources within a coverage area that provides a connection to the terminal. The terminal managed by the base station can exchange data with the base station through a process of transmitting and receiving radio signals using allocated resources.

The base station may be configured variously according to the size of its coverage providing connectivity. Base stations providing various coverage areas may be overlapped and provide radio access to terminals. In general, the size of the coverage provided by the base station depends on a frequency, and decreases as the frequency increases. A plurality of transmission and reception points (TRPs) are devices that transmit and receive radio signals to and from a terminal, constitute a part of the base station, and may constitute the base station at the same location or distributed locations. The base station may be configured in a centralized manner for radio access functions or in a distributed manner for the functions. The base station whose radio access functions are distributed may be configured with a central unit (CU) providing upper functions and at least one distributed unit (DU) providing lower functions.

The terminal may transmit and receive data by transmitting and receiving radio signals with a cell provided by the base station over a radio section and using a radio access protocol that hierarchically configures a radio access function. A service packet generated at a service layer may be delivered to a counterpart through the radio access protocol. The base station may distribute functions of the radio access protocol in functional units and may be configured as a set of distributed devices. The radio access functions provided by the radio access protocol generally use a single frequency band and configure a bandwidth part within the band. When multiple frequencies are used, carrier aggregation (CA) and dual connectivity (DC) may be employed depending on how the radio access protocol is configured.

A technique of using terahertz band frequencies is a multi-transmission and reception point (Multi-TRP) technique, where each TRP may be configured with a short service radius. Therefore, when the terminal moves, a signal strength may rapidly decrease at a boundary of a TRP, resulting in degraded quality of the radio signal. Accordingly, a method for the terminal to receive a radio signal with high quality at the TRP boundary is required.

### SUMMARY

The present disclosure for resolving the above-described problems is directed to providing a method and apparatus for inter-CU LTM handover.

According to a first exemplary embodiment of the present disclosure, a method of a terminal may comprise: transmitting a measurement report to a serving cell corresponding to an identifier associated with a first centralized unit (CU); receiving information on at least one candidate cell including an identifier associated with a second CU from the serving cell through a radio resource control (RRC) reconfiguration message; transmitting a measurement report on the at least one candidate cell to the serving cell; receiving a cell switching command medium access control (MAC) control element (CE) for a target cell among the at least one candidate cell from the serving cell; performing a random access procedure for the target cell based on the cell switching command MAC CE; and completing a connection to the target cell.

When the identifier associated with the first CU is different from the identifier associated with the second CU, a packet data convergence protocol (PDCP) and/or radio link control (RLC) layer may be initialized during a process of moving to the target cell.

The cell switching command MAC CE may include information on a physical random access channel (PRACH) resource and a PRACH preamble of the target cell, and the random access procedure may be performed using the PRACH resource and the PRACH preamble.

The cell switching command MAC CE may include a transmission configuration indication (TCI) state identifier (ID) and/or an uplink (UL) TCI state ID for the target cell.

According to a second exemplary embodiment of the present disclosure, a method of a first centralized unit (CU) operating a serving cell may comprise: receiving a measurement report from a terminal; transmitting a candidate cell information request to a second CU; receiving a candidate cell information response from the second CU; transmitting information on at least one candidate cell including an identifier associated with the second CU to the terminal; receiving a measurement report on the at least one candidate cell; and transmitting a cell switching command medium access control (MAC) control element (CE) for a target cell among the at least one candidate cell to the terminal, wherein the second CU receives a signal transmitted by the terminal to the target cell.

The candidate cell information request may use a HANDOVER REQUEST message, and the candidate cell information response may use a HANDOVER REQUEST ACKNOWLEDGE message.

The method may further comprise: after the receiving of the candidate cell information response, transmitting a candidate cell information change request to the second CU; and receiving a candidate cell information change response from the second CU.

The candidate cell information change request may be transmitted using a first message, and the candidate cell information change response may be received using a second message.

The method may further comprise: after the transmitting of the information on the at least one candidate cell to the terminal, receiving time advance (TA) information from the second CU, wherein the cell switching command MAC CE may include the TA information.

In the receiving of the TA information from the second CU, the TA information may be received from the second CU using a TA INFORMATION TRANSFER message.

In the transmitting of the candidate cell information request, an early synchronization information request may be additionally transmitted to the second CU, and in the receiving of the candidate cell information response, early synchronization configuration information for candidate cell(s) may be additionally received from the second CU.

The early synchronization configuration information may include information on a physical random access channel (PRACH) resource and a PRACH preamble for each of the candidate cell(s).

The PRACH resource may be indicated by a synchronization signal block/physical broadcast channel (SS/PBCH) block index and a PRACH mask index, and the PRACH preamble may be indicated by a random access preamble index.

The early synchronization configuration information may include a transmission configuration indication (TCI) state identifier (ID) and/or an uplink (UL) TCI state ID for each of the candidate cell(s).

Information on a PRACH resource and a PRACH preamble of the target cell may be additionally received in the receiving of the TA information from the second CU, and the terminal may receive the information on the PRACH resource and the PRACH preamble of the target cell through the cell switching command MAC CE, or may receive the information on the PRACH resource and the PRACH preamble of the target cell directly from the target cell by being connected to the target cell.

The PRACH resource may be indicated by a SS/PBCH block index and a PRACH mask index, and the PRACH preamble may be indicated by a random access preamble index.

The cell switching command MAC CE may include a TCI state ID and/or a UL TCI state ID for the target cell.

The method may further comprise: receiving a HANDOVER SUCCESS message from the second CU that has received a signal transmitted by the terminal to the target cell.

The second CU, which receives the signal transmitted by the terminal to the target cell, may transmit a request for switching a wired path to an access and mobility function (AMF) and receive a response to the request for switching the wired path from the AMF.

The second CU may transmit a PATH SWITCH REQUEST message as the request for switching the wired path, and receive a PATH SWITCH REQUEST ACKNOWLEDGE message in response to the request for switching the wired path.

According to exemplary embodiments of the present disclosure, mobility can be improved through an inter-centralized unit (CU) L1/L2 triggered mobility (LTM) handover procedure, and in particular, early synchronization between a source gNB and a target gNB and fast cell switching based on L1/L2 triggers can be enabled to minimize a handover delay. In addition, by configuring a plurality of LTM candidate cells and utilizing implicit or explicit cell indexes, the mobility of the terminal can be managed more effectively. Furthermore, by utilizing a CFRA procedure, efficient UL synchronization can be performed by a terminal using pre-allocated PRACH resources and PRACH preambles, and the target gNB can adjust a UL transmission timing based on a timing advance (TA) value measured by the target gNB, thereby enhancing the stability and reliability of the handover.

### BRIEF DESCRIPTION OF DRAWINGS

FIG. 1 is a conceptual diagram illustrating an exemplary embodiment of a wireless communication network.

FIG. 2 is a block diagram illustrating an exemplary embodiment of a communication node constituting a wireless communication network.

FIG. 3 is a diagram illustrating a connection scheme (example) between a base station and a core network in a wireless communication network using a base station having a distributed structure.

FIGS. 4A and 4B are a sequence chart illustrating a method for inter-CU LTM handover according to an exemplary embodiment of the present disclosure.

FIG. 5 is a sequence chart illustrating an inter-CU LTM handover method according to another exemplary embodiment of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g. Long-Term Evolution (LTE) communication system or LTE-A communication system), the 5G communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication network may include a terrestrial network and a non-terrestrial network. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In other words, “an operation (e.g. transmission operation) is configured in a communication node” may mean that the communication node receives “configuration information (e.g. information elements, parameters) for the operation” and/or “information indicating to perform the operation”. “An information element (e.g. parameter) is configured in a communication node” may mean that “the information element is signaled to the communication node (e.g. the communication node receives the information element)”.

The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)). A signaling message may be at least one of an SI signaling message (e.g. SI message), an RRC signaling message (e.g. RRC message), a MAC CE signaling message (e.g. MAC CE message or MAC message), or a PHY signaling message (e.g. PHY message).

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A wireless communication network to which exemplary embodiments according to the present disclosure are applied will be described. A wireless communication network to which exemplary embodiments according to the present disclosure are applied is not limited to the contents described below, and exemplary embodiments according to the present disclosure may be applied to various wireless communication networks. Here, the wireless communication network may be used as the same meaning as a wireless communication system.

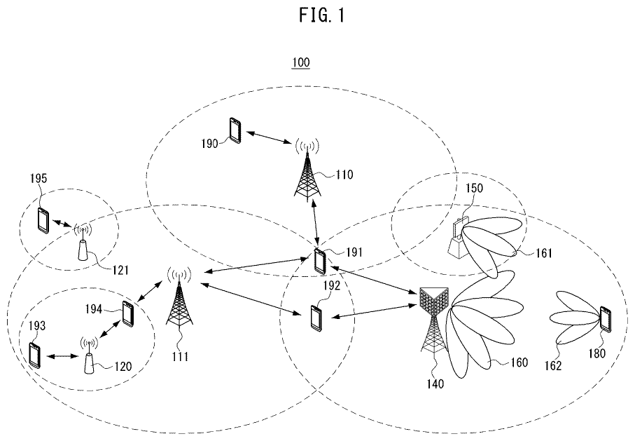

FIG. 1 is a conceptual diagram illustrating an exemplary embodiment of a wireless communication network.

Referring to FIG. 1, a wireless communication network 100 may comprise a plurality of communication nodes 110, 111, 120, 121, 140, 150, 180, 190, 191, 192, 193, 194, and 195. Each of the plurality of communication nodes may support at least one communication protocol. For example, each of the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a space division multiple access (SDMA) based communication protocol, or the like.

The wireless communication network 100 may comprise a plurality of base stations (BSs) 110, 111, 120, 121, 140, and 150, and a plurality of terminals (user equipments (UEs)) 190, 191, 192, 193, 194, 195, and 180. Each of the plurality of base stations 110, 111, and 140 may form a macro cell. Alternatively, each of the plurality of base stations 120, 121, and 150 may form a small cell. The plurality of base station 190 and 191 may belong to a cell coverage of the base station 110. The plurality of base stations 120 and 121 and the plurality of terminals 191, 192, 193, 194, and 195 may belong to a cell coverage of the base station 111. The base station 150 and the plurality of terminals 191, 192, and 180 may belong to a cell coverage of the base station 140.

Each of the plurality of communication nodes 110, 111, 120, 121, 140, 150, 180, 190, 191, 192, 193, 194, and 195 may support a radio access protocol specification of a radio access technology based on cellular communication (e.g. long term evolution (LTE), LTE-Advanced (LTE-A), new radio (NR), etc. which are defined in the 3rd generation partnership project (3GPP) standard). Each of the plurality of base stations 110, 111, 120, 121, 140, and 150 may operate in a different frequency band, or may operate in the same frequency band. The plurality of base stations 110, 111, 120, 121, 140, and 150 may be connected to each other through an ideal backhaul or a non-ideal backhaul, and may exchange information with each other through the ideal backhaul or the non-ideal backhaul. Each of the plurality of base stations 110, 111, 120, 121, 140, and 150 may be connected to a core network (not shown) through a backhaul. Each of the plurality of base stations 110, 111, 120, 121, 140, and 150 may transmit data received from the core network to the corresponding terminals 190, 191, 192, 193, 194, 195, and 180, and transmit data received from the corresponding terminals 190, 191, 192, 193, 194, 195, and 180 to the core network.

Each of the plurality of communication nodes 110, 111, 120, 121, 140, 150, 180, 190, 191, 192, 193, 194, and 195 constituting the wireless communication network 100 may exchange signals with a counterpart communication node without interferences by using a beam formed through a beamforming function using multiple antennas.

Each of the plurality of base stations 110, 111, 120, 121, 140, and 150 may support multiple input multiple output (MIMO) transmissions using multiple antennas (e.g. single user (SU)-MIMO, multi user (MU)-MIMO, massive MIMO, etc.), coordinated multipoint (COMP) transmission, carrier aggregation (CA) transmission, unlicensed band transmission, device-to-device (D2D) communication, proximity services (ProSe), dual connectivity transmission, and the like.

Each of the plurality of base stations 110, 111, 120, 121, 140, and 150 may be referred to as a NodeB, evolved NodeB, gNB, ng-eNB, radio base station, access point, access node, node, radio side unit (RSU), or the like. Each of the plurality of terminals 190, 191, 192, 193, 194, 195, and 180 may be referred to as a user equipment (UE), terminal, access terminal, mobile terminal, station, subscriber station, mobile station, portable subscriber station, node, device, Internet of Things (IoT) device, mounted apparatus (e.g. mounted module/device/terminal or on-board device/terminal, etc.), or the like. The content of the present invention is not limited to the above-mentioned terms, and they may be replaced with other terms that perform the corresponding functions according to a radio access protocol according to a radio access technology (RAT) and a functional configuration supporting the same.

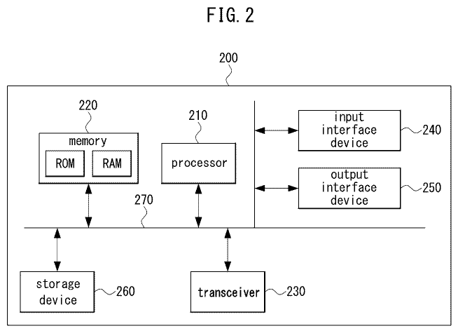

FIG. 2 is a block diagram illustrating an exemplary embodiment of a communication node constituting a wireless communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with exemplary embodiments of the present invention are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Each of the plurality of communication nodes 110, 111, 120, 121, 140, 150, 180, 190, 191, 192, 193, 194, and 195 constituting the wireless communication network 100 may be implemented in the form of the communication node 200.

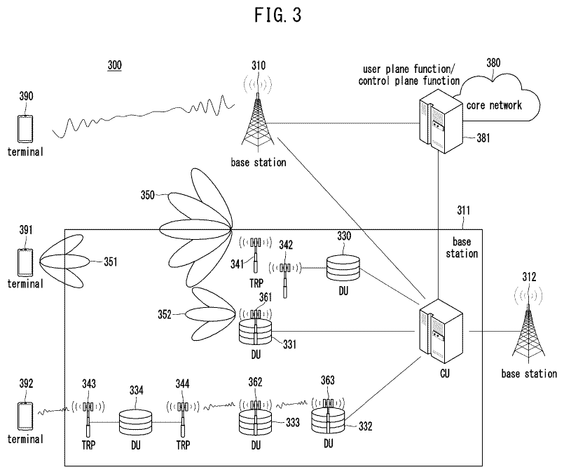

FIG. 3 is a diagram illustrating a connection scheme (example) between a base station and a core network in a wireless communication network using a base station having a distributed structure.

Referring to FIG. 3, in a wireless communication network, base stations 310, 311, and 312 may be connected to an end node 381 of a core network 380 through a backhaul, and transfer data exchanged between a plurality of terminals 390, 391, and 392 and the core network 380 in both directions. The core network 380 may correspond to a 4G core network supporting 4G communication or a 5G core network supporting 5G communication. Here, the core network 380 supporting 4G communication may include a mobility management entity (MME), a serving-gateway (S-GW), a packet data network (PDN)-gateway (P-GW), and the like. The core network 380 supporting 5G communication may include an access and mobility management function (AMF), a user plane function (UPF), a P-GW, and the like.

Here, the end node 381 of the core network 380 may provide a user plane function for exchanging packets with the plurality of terminals 390, 391, and 392 and a control plane function for managing access and mobility of the terminals. The user plane function may be a serving-gateway (S-GW), a user plane function (UPF), or the like. The control plane function may be an MME, an AMF, or the like. In the present disclosure, the terms ‘S-GW’, ‘UPF’, ‘MME’, and ‘AMF’ are described as examples for better understanding. However, the present disclosure is not limited to such terms, and the terms may be replaced with other terms indicating the corresponding functions according to a radio access protocol of a radio access technology (RAT) or entities performing the corresponding functions according to constituent functions of the core network.

The base station 311 composed of a set of distributed devices configured by splitting the functions of the radio access protocol may include a central unit (CU) 320 with a centralized function, a plurality of distributed units (DUs) 330, 331, 332, 333, and 334 with distributed functions, and a plurality of transmission and reception points (TRPs) 340, 341, and 342 for transmitting and receiving signals. In FIG. 3, only the base station 311 is shown as a base station having a distributed structure, but the other base stations 310 and 312 may also be configured identically or similarly to the base station 311 having a distributed structure.

The CU 320, which includes upper functions of the radio access protocol, may be connected to the plurality of DUs 330, 331, 332, 333, and 334 in the direction of a radio section, and may be connected to the end node 381 in the direction of the core network 380. In addition, the CU 320 may be connected to the plurality of neighboring base stations 310 and 312. Each of the plurality of DUs 331, 332, and 333 which include lower functions of the radio access protocol may be connected to a plurality of TRPs, and each of the plurality of DUs 330 and 334 may be connected to a plurality of TRPs 340, 341, and 342 located at remote locations.

Each of the plurality of base stations 310, 311, and 312 may include a plurality of TRPs for transmitting and receiving radio signals, and may use data detected from the signals transmitted and received by the plurality of TRPs. Each of the plurality of TRPs 331, 332, 333, 340, 341, and 342 may operate independently or in cooperation with neighboring TRPs. Each of the plurality of TRPs 331, 332, 333, 340, 341, and 342 may exchange signals with a counterpart communication node without interference through a plurality of beams 350 or 352 formed based on g a beamforming function using multiple antennas. Each of the plurality of TRPs 331, 332, 333, 340, 341, and 342 may refer to a (remote) radio transceiver, remote radio head (RRH), wireless antenna, transmission point (TP), transmission and reception point (TRP), or the like.

Each of the plurality of DUs 330, 331, 332, 333, and 334 may be wired or wirelessly connected to a communication node in the direction of the core network 380. Each of the plurality of DUs 330, 331, and 332 wired to the communication node in the direction of the core network 380 may configure some functions of the radio access protocol of the base station in the radio section to provide radio access to at least one terminal, and may be connected to the CU 320 in a wired section. Each of the plurality of DUs 333 and 334 wirelessly connected to the communication node in the direction of the core network 380 may configure some functions of the radio access protocol of the base station in the radio section to provide radio access to at least one terminal, and may configure some functions of the radio access protocol of the terminal in the radio section to wirelessly connect to a relay device in the direction of the CU 320, thereby being connected to the CU 320 in both directions.

For example, the DU 333 may wirelessly connect to the DU 332 in the direction of the CU 320. Therefore, the DU 332 may be a relay device that relays the connection between the DU 333 and the CU 320. The DU 334 may wirelessly access the DU 333 in the direction of the CU 320. Therefore, the DU 333 may be a relay device that relays the connection between the DU 334 and the CU 320. The plurality of TRPs 343 and 344 connected to the DU 334 may form a beam or may be configured in a region where interference is reduced by a physical method. The TRP 343 may configure some functions of the base station radio access protocol, and the TRP 344 may configure some functions of the terminal radio access protocol.

When a plurality of communication nodes exchange signals using a plurality of beams 350, 351, and 352 formed by the respective communication nodes, each communication node may exchange signals through a beam paired (configured) with a counterpart node. To this end, a plurality of beams of the counterpart communication node are searched, reception strength of each beam is measured, and at least one beam for exchanging signals may be configured based on selection by a communication node participating in communication. A quality of a radio channel can be maintained by changing the beam of the communication node to correspond to a change of a radio channel state or the movement of the communication node.

Hereinafter, a structure and layer-specific functions of a radio access protocol that provides a radio connection between a base station and a terminal in a wireless communication network will be described. The structure of the radio access protocol and the functions of each layer are described for the purpose of describing specific exemplary embodiments only, and are not intended to limit the contents of the present disclosure, and include changes or substitutions included in the concept and technical scope of the proposed techniques.

The radio access protocol may provide functions in which a plurality of communication nodes exchange data and control information by using radio resources in a radio section, and may be hierarchically configured. In the cellular communication (e.g., long term evolution (LTE), LTE-Advanced (LTE-A), new radio (NR), etc. which are the 3rd generation partnership project (3GPP) standards), the radio access protocol may include a radio layer 1 (RL1) which configures physical signals; a radio layer 2 (RL2) which controls radio transmissions in radio resources shared by a plurality of communication nodes, transmits data to a counterpart node, and converges data from the counterpart node; and a radio layer 3 (RL3) which performs radio resource managements such as network information sharing, radio connection management, mobility management, and quality of service (QoS) management for multiple communication nodes participating in the mobile network.

The radio layer 1 may be a physical layer and may provide functions for data transfer. The radio layer 2 may include sublayers such as a medium access control (MAC), a radio link control (RLC), a packet data convergence protocol (PDCP), a service data adaptation protocol (SDAP), and the like. The radio layer 3 may be a radio resource control (RRC) layer, and may provide an AS layer control function.

Operations such as a start, stop, reset, restart, or expire of a timer defined in relation to an operation of the timer defined or described in the present disclosure may mean or include the operation of the timer or a counter for the corresponding timer without being separately described.

Hereinafter, operation methods of communication nodes in a mobile communication network according to exemplary embodiments of the present disclosure will be described. Even when a method (e.g., transmission or reception of a signal) performed at a first communication node among communication nodes is described, the corresponding second communication node may perform a method (e.g., reception or transmission of the signal) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the present disclosure, a base station node may be represented as a gNB from the perspective of a radio interface, and may be configured with a CU and at least one DU from the perspective of a radio access network (RAN). In describing a signaling procedure, content described based on the CU may be applied to the gNB, and content described based on the gNB may be applied to the CU.

L1/L2 triggered mobility (LTM) has been introduced as a method for providing continuous connectivity by reducing a handover delay time and an interruption time for a moving terminal. LTM may provide continuous connectivity when the terminal performs cell mobility within the same CU, that is, in case of intra-CU LTM. In LTM, the terminal may transmit a physical layer (layer 1, L1) measurement report to a base station (gNB), and the base station may decide a handover based on the report. When a handover is determined to be required, the base station may transmit a medium access control (MAC) control element (CE), which is a layer 2 (L2) signaling message, to the terminal. Accordingly, the terminal may maintain a connection by switching from a serving cell to a target cell. By utilizing the L1 measurement and the L2 signaling message, a handover processing time can be shortened, enabling faster handover execution. In the intra-CU LTM procedure, which is performed for a purpose of switching between cells within the same CU, a packet data convergence protocol (PDCP) may be maintained, and thus PDCP relocation and security key update are not performed.

The network may preconfigure candidate cell(s) to which LTM is applied. The terminal may perform a timing advance (TA) procedure in advance for the candidate cell(s) configured by the network. That is, the terminal may perform the TA procedure in advance for the candidate cell(s) according to a procedure and scheme configured by the network, and when accessing a target cell later, the terminal may perform a connection establishment using a preset TA value. The network may configure a plurality of LTM candidate cells, and the terminal may continue to perform uplink (UL) synchronization and LTM candidate cell switching procedures repeatedly while maintaining the configuration of the LTM candidate cells even after completing the LTM procedure. Such a procedure that supports repeated cell switching may be referred to as a sequent LTM procedure. The intra-CU LTM procedure is a procedure in which the terminal moves to another cell within the same CU (gNB). In the intra-CU LTM procedure, since the gNB is connected to both the serving cell and the target cell and manages them, the gNB may perform a procedure for establishing a radio connection with the terminal without exchanging candidate cell configurations or TA information with another gNB.

In the present disclosure, when a serving CU and a target CU are different (i.e. in an inter-CU LTM procedure), that is, when inter-CU mobility is performed, the serving CU and the target CU may perform a handover procedure through an Xn interface. The serving CU that decides handover may transmit a handover request to the target CU, and the target CU may transmit a handover response to the serving CU when the handover request is approved.

The serving CU may deliver radio connection information including connection information of the terminal and information of the target cell to the target CU in form of an RRC container. The target CU may control connection of the terminal with the target cell based on the information, and may perform a procedure including admission control. The serving CU may perform data forwarding to the target CU at a time of deciding the handover. To achieve a lossless handover, the target CU may establish a quality of service (QoS) flow and a data radio bearer (DRB) connection, and may use a downlink forwarding tunnel for downlink data forwarding. For data forwarding, an early status transfer message and a sequence number (SN) status transfer message may be used. During the handover preparation process, the serving CU may establish a data forwarding tunnel with the target CU, and perform PDCP data forwarding at a time when the handover is executed.

When the terminal is connected to the target CU, the target CU may transmit a handover success message to the source CU. In response, the source CU may receive an SN status transfer message. In the downlink, the source CU may perform data forwarding, and in the uplink, the target gNB may receive data transmitted by the terminal and deliver the data to a User Plane Function (UPF). In addition, a path switching procedure may be performed in the downlink to optimize a path between a 5G Core Network (5GC) and the target CU. When the handover is completed, the target CU may perform the path switching procedure with the 5G CN to establish an optimal data transmission path. When the terminal is connected to the target CU, the target CU completes the handover success procedure and performs the path switching procedure with the 5G CN.

The present disclosure provides an L1/L2 Triggered Mobility (LTM) procedure to the terminal and provides an inter-CU LTM handover procedure to implement inter-CU LTM mobility. In the following description, a source gNB may have the same meaning as a source CU, serving CU, serving cell, or serving gNB, and a target gNB may have the same meaning as a target CU or target cell. The source gNB (i.e. source base station) may be a base station that operates a source cell, and the target gNB (i.e. target base station) may be a base station that operates a target cell. Meanwhile, the inter-CU LTM handover may refer to an LTM handover performed in a situation where the source cell and the target cell belong to different CUs.

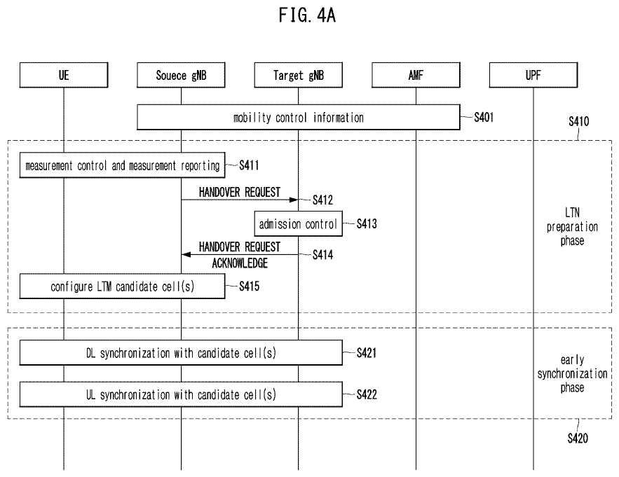

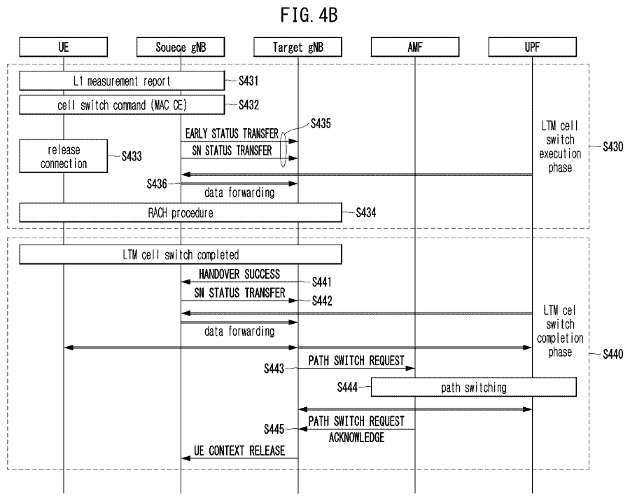

FIGS. 4A and 4B are a sequence chart illustrating a method for inter-CU LTM handover according to an exemplary embodiment of the present disclosure.

Referring to FIGS. 4A and 4B, an inter-CU LTM handover method according to an exemplary embodiment of the present disclosure may comprise: an LTM preparation phase S410, an early synchronization phase S420, an LTM cell switch execution phase S430, and an LTM cell switch completion phase S440. The phases illustrated in FIG. 4A and the phases illustrated in FIG. 4B together constitute the inter-CU LTM handover method. That is, the phases illustrated in FIG. 4B may be performed after the phases illustrated in FIG. 4A.

In step S401, an AMF of a core network may provide mobility control information to a source gNB and a target gNB. Description on step S401 is omitted in the present disclosure.

In the LTM preparation phase S410, the source gNB may control measurement of the terminal and receive measurement values reported by the terminal through a measurement report (S411). The source gNB may determine LTM candidate cell(s) for the terminal based on the measurement report. Thereafter, the source gNB may transmit a HANDOVER REQUEST message to the target gNB to request a handover (S412). The target gNB may perform admission control on the handover for the terminal (S413), and may include a result of the admission control in a HANDOVER REQUEST ACKNOWLEDGE message and transmit it to the source gNB (S414). The source gNB may perform a procedure for configuring the determined LTM candidate cell(s) for the terminal, and in this process, the source gNB and the terminal may exchange an RRC reconfiguration message and an RRC reconfiguration complete message (S415).

In the early synchronization phase S420, the network may perform early synchronization with the LTM candidate cell(s). When early synchronization is performed, the terminal may synchronize with a target gNB and perform downlink (DL) synchronization and uplink (UL) synchronization (S421, S422). In the UL synchronization procedure, the target gNB may acquire a TA value of the terminal and deliver information thereon to the terminal.

In the LTM cell switch execution phase S430, when a preconfigured handover event occurs, the terminal may report measurement values to the source gNB through an L1 measurement report (S431). The source gNB may transmit an LTM cell switch command to the terminal to initiate a cell switching operation in form of a MAC CE message (S432), and the MAC CE message may include the TA value of the terminal measured by the target gNB. Thereafter, the terminal may detach from the source gNB cell (S433), and perform a procedure (i.e. a RACH procedure) to access the target gNB cell (S434). Meanwhile, the source gNB may transmit an EARLY STATUS TRANSFER message and an SN STATUS TRANSFER message to the target gNB (S435), and may perform a data forwarding procedure for downlink data at a PDCP layer (S436).

In the LTM cell switch completion phase S440, the terminal may transmit an RRCReconfigurationComplete message to the target gNB and complete the LTM cell switching. Once the LTM cell switching is completed, the target gNB may transmit a HANDOVER SUCCESS message to the source gNB (S441). The source gNB may subsequently transmit an SN STATUS TRANSFER message (S442). The target gNB may proceed with a procedure to switch a data forwarding path previously used by the source gNB (S444), and for this purpose, the target gNB may exchange a PATH SWITCH REQUEST message and a PATH SWITCH REQUEST ACKNOWLEDGE message with the UPF to optimize the data path (S443, S445).

While the terminal is moving by being connected to the serving cell, the terminal may periodically perform a process of identifying cells and measuring signal strengths of the respective cells based on received radio signals. According to measurement reporting criteria configured by the serving cell, the terminal may report measurement values for the respective cells to the serving cell. The source gNB may select candidate cells for preparing LTM mobility based on radio measurement values and the like. The source gNB may perform an inter-CU LTM preparation procedure for LTM candidate cells included in gNB(s) different from the source gNB. The source gNB may perform an intra-CU LTM preparation procedure for LTM candidate cells included in the source gNB.

In intra-CU LTM, the LTM procedure may be performed within a single gNB, and in inter-CU LTM, the LTM procedure may be performed between two gNBs, with an Xn interface additionally configured between the two gNBs.

In the process of configuring LTM candidate cells, the source gNB may request the target gNB to configure LTM candidate cells and collect information on the LTM candidate cells approved by the target gNB. In the process of configuring LTM candidate cells, LTM information and early synchronization information may be exchanged between the source gNB and the target gNB. The source gNB may transmit LTM candidate cell request information and early synchronization request information to the target gNB by including them in the HANDOVER REQUEST message, and the target gNB may transmit LTM candidate cell configuration information and early synchronization configuration information to the source gNB by including them in the HANDOVER REQUEST ACKNOWLEDGE message. The source gNB may provide an LTM reference cell configuration in the radio section for the LTM candidate cells to the target gNB by utilizing information of the radio connections configured and operated in the serving cell. Upon receiving the LTM reference cell configuration, the target gNB may perform a process of determining whether each of the LTM candidate cells is permitted and select LTM candidate cells. The target gNB may perform a process of notifying the source gNB of the selected LTM candidate cells and provide configuration fields for wired and radio section connections for each of the selected LTM candidate cells to the source gNB.

In the process of negotiating LTM candidate cells between the source gNB and the target gNB, the content of the messages exchanged may vary depending on which of the source gNB or the target gNB takes the initiative in determining the configuration information of the LTM candidate cells.

In the case where the source gNB takes the initiative in determining the configuration information of the LTM candidate cells, the source gNB may directly determine configuration values of the radio and wired sections required for each LTM candidate cell. In this case, the source gNB may transmit first reference configuration information, including identifiers of cells considered as LTM candidate cells and configuration values for the radio and wired sections of each cell, to the target gNB. The target gNB may select a portion of the cells as LTM candidate cells based on the first reference configuration information and may transmit information of the selected cells to the source gNB. In this case, the information transmitted by the target gNB may include second reference configuration information, composed of the identifiers of the selected LTM candidate cells and configuration values for the radio and wired sections of each cell. The second reference configuration information may have some fields that are the same as those of the first reference configuration information transmitted by the source gNB, while some specific fields may be different. The source gNB may configure final configuration information of the LTM candidate cells by using cell-specific configuration information received from the target gNB and, for fields not included therein, the first reference configuration information.

Meanwhile, in the case where the target gNB takes the initiative in determining the configuration information, the source gNB may transmit identifiers of cells considered as LTM candidate cells to the target gNB, and the target gNB may select some of the cells as LTM candidate cells and generate configuration information for the radio and wired sections for each cell. As a method of delivering configuration information for multiple cells, both reference configuration information commonly applied to the multiple cells and cell-specific configuration information individually applied to each cell may be used. The target gNB may transmit the configuration information for each LTM candidate cell individually to the source gNB or may configure single LTM candidate configuration information including the reference configuration information and the cell-specific configuration information and transmit it to the source gNB.

When the source gNB cannot accept the LTM candidate cell configuration information received, the source gNB may perform a procedure to request a change of the configuration information from the target gNB. In this procedure, the source gNB may request a change by transmitting to the target gNB identifiers and configuration information of LTM candidate cells to be ultimately configured for the terminal. The final configuration information delivered by the source gNB to the target gNB may include connection information and configuration values for the radio and wired sections. The target gNB may verify the configuration information of the requested LTM candidate cells and, by determining whether the configuration is acceptable in the radio and wired sections, transmit the accepted configuration information to the source gNB as a response message. The configuration information of the LTM candidate cells may be composed of individual configuration information for each cell, or may be composed of common configuration information and cell-specific configuration information. In addition, the LTM candidate cell change procedure between the source gNB and the target gNB may include addition and release of LTM candidate cells.

In the inter-CU LTM preparation procedure, the HANDOVER REQUEST message transmitted by the source gNB to the target gNB and the HANDOVER REQUEST ACKNOWLEDGE message transmitted by the target gNB to the source gNB may be used. These two messages may be used not only in the LTM candidate cell configuration process but also in the LTM candidate cell change procedure. Alternatively, the two messages may be used only in the configuration process, and separate messages may be used in the change procedure. The present disclosure is not limited by the names of the messages used and may be defined by the content of the information exchanged between the source gNB and the target gNB in each procedure or step.

The source gNB and the target gNB may utilize field structures of the RRC messages as a method of exchanging configuration information of LTM candidate cells. An RRC container may be used in the LTM candidate cell request and response fields within the HANDOVER REQUEST and HANDOVER REQUEST ACKNOWLEDGE messages. That is, the LTM candidate cell request and response information may be included as a field configuration within the RRC messages, and the source gNB and the target gNB may exchange the configuration information of the LTM candidate cells through such RRC fields. The field configuration using the RRC container scheme may also be utilized in other messages exchanged between the source gNB and the target gNB.

The serving gNB may configure LTM candidate cells and deliver configuration information of the LTM candidate cells to the terminal through an RRC reconfiguration procedure. The serving gNB may classify the LTM candidate cells on a CU basis and configure a cell identifier and connection configuration information for a radio section for each LTM candidate cell. The serving gNB may serve as the source gNB in an interface between gNBs, exchange messages with the target gNB to select inter-CU LTM candidate cells, and select intra-CU LTM candidate cells through internal interfaces. Thereafter, the serving gNB may transmit an RRC reconfiguration message to the terminal and may include the identifiers and radio connection configuration information of the LTM candidate cells in the RRC reconfiguration message. The terminal may store the received configuration information of the LTM candidate cells and, and upon receiving a cell switch command from the serving gNB in form of a MAC CE, may switch the connection from the serving cell to the target cell. The terminal may receive a cell identifier of the target cell through the MAC CE.

The identifiers of the LTM candidate cells may be provided to the terminal explicitly or implicitly. In the explicit scheme, the identifiers of the LTM candidate cells are included in the LTM candidate cell configuration information in the RRC reconfiguration message, and the terminal may store it individually for each candidate cell. In contrast, in the implicit scheme, the identifiers of the LTM candidate cells are not directly included in the RRC reconfiguration message, and the terminal may be configured to calculate it according to a specific rule. For example, sequential identifiers may be calculated based on indexes of the LTM candidate cells. If an identifier of the first candidate cell is 0, identifiers such as 1, 2 may be sequentially assigned to subsequent cells.

In addition, when multiple LTM candidate cell groups exist, continuous identifiers may be assigned across the groups. For example, if an identifier of the first LTM candidate cell is 10, and the first group composed of three cells and the second group composed of two cells are configured, identifiers may be assigned as 10, 11, 12 and 13, 14.

The terminal may configure multiple LTM candidate cells in the radio section, and the LTM candidate cells may be associated with an intra-CU LTM procedure and/or an inter-CU LTM procedure. The intra-CU LTM procedure is a procedure in which the terminal switches a cell within the same CU and establishes a connection from the serving cell to the target cell. The protocol layers related to connection in the radio section are PDCP, RLC, MAC, and PHY layers, and a gNB constituting the serving cell is composed of a CU and a DU. In this case, the CU includes the PDCP and RLC layers, and the DU includes the MAC and PHY layers. When establishing a connection by switching a cell within the same CU, the PDCP and/or RLC layers may be continuously used between the serving cell and the target cell and therefore are not reset. In addition, when the connection is established by switching within the same DU, the MAC layer is also continuously used and not reset (initialized). In contrast, the PHY layer is reset during the process of moving from the serving cell to the target cell. The inter-CULTM procedure is a procedure for establishing a connection from the serving cell to a target cell belonging to a different CU, and in this case, the PDCP and/or RLC layers are reset when the connection is moved. Here, the reset of each protocol includes reconfiguration.

The serving cell may configure multiple LTM candidate cells for the terminal and may need to identify whether each candidate cell belongs to the same CU or to a different CU. When the terminal moves to the target cell, if the target cell belongs to a different CU, the terminal may reset the PDCP and/or RLC layers. In contrast, if the CU is the same, the PDCP and/or RLC layers may be used continuously. In the LTM candidate cell configuration process, a CU-related identifier may be configured for each cell. Cells belonging to the same CU use the same identifier, and cells belonging to different CUs use different identifiers. The terminal may receive a CU-related identifier connected to each LTM candidate cell in the configuration process and determine whether the cell belongs to the same CU as the serving cell based on the identifier. That is, the terminal regards an LTM candidate cell having a CU-related identifier different from that of the serving cell as a cell belonging to a different CU.

The terminal may receive the RRC reconfiguration message and obtain the configuration information of the LTM candidate cells. In a subsequent step where LTM cell switching is executed, the terminal may receive the identifier of the target LTM candidate cell and switch the connection to the corresponding cell. In this case, the terminal may compare the CU-related identifiers of the serving cell and the target cell, and if they are the same, may switch the connection using the PDCP and RLC layer configurations continuously. Conversely, if the identifiers are different, the terminal may reset the PDCP and RLC layers and establish a connection to the target cell.

As described above, in the early synchronization phase S420, the terminal (UE) may perform a DL and UL synchronization procedure with the target gNB. The synchronization procedure may be classified into DL synchronization and UL synchronization. The DL synchronization is a process in which the terminal receives a synchronization signal transmitted by the gNB and acquires synchronization based on the received synchronization signal. The UL synchronization is a process in which the terminal transmits a signal that is received by the gNB, and the terminal acquires a TA value calculated by the gNB. The terminal may adjust a UL signal transmission timing based on the acquired TA value.

Meanwhile, the UL synchronization procedure may be performed in a scheme in which only the target gNB participates or in a scheme in which both the source gNB and the target gNB participate.

In the UL synchronization scheme in which only the target gNB participates, the terminal may transmit a physical random access channel (PRACH) preamble to the target gNB to acquire TA alignment. The terminal may transmit the PRACH preamble in a PRACH resource of the target gNB, and the target gNB may receive it and calculate the TA value. Thereafter, the target gNB may transmit a random access response (RAR) message including the calculated TA value to the terminal to deliver the TA value. The terminal may adjust a UL transmission timing based on the received TA value. The above-described scheme is similar to a UL synchronization scheme in a general initial random access procedure. However, it differs in that the terminal performs the TA alignment procedure with the target gNB instead of the source gNB.

In the UL synchronization scheme involving both the source gNB and the target gNB, the terminal may acquire information related to Random Access Channel (RACH) access from the source gNB. This information includes details on a PRACH preamble intended for transmission to the target gNB. Subsequently, the terminal may transmit the PRACH preamble to the target gNB. Upon receiving the PRACH preamble, the target gNB may calculate a TA value and deliver the TA value to the source gNB. The source gNB may deliver the calculated TA value to the terminal through the LTM cell switch command MAC CE. The terminal may adjust its UL transmission timing when connecting to the target gNB based on the TA value received through the source gNB.

In order for the terminal to perform early synchronization by transmitting the PRACH preamble to the target gNB, the terminal may need to receive PRACH preamble configuration information for each LTM candidate cell while the serving cell configures the LTM candidate cells. The serving gNB may request the target gNB to provide PRACH preamble configurations necessary for early synchronization. In response, the target gNB may deliver configuration information including PRACH resources, parameters, and preamble indexes to the terminal. The serving gNB may deliver the configuration information to the terminal, enabling the terminal to perform early synchronization with the target cell. The terminal may transmit the PRACH preamble within the allocated PRACH resources by applying the provided PRACH parameters. The target gNB may receive the PRACH preamble and calculate a TA value. The calculated TA value may be delivered from the target gNB to the source gNB through a TA Information Transfer message. Once the target cell is selected for LTM cell switching, the serving gNB may include the TA information and cell identifier in the LTM cell switch command MAC CE, and transmit the LTM cell switch command MAC CE to the terminal. The above-described scheme corresponds to a contention-free random access (CFRA) scheme, since the target gNB explicitly allocates the PRACH resource, PRACH parameters, and PRACH preamble (e.g. a random access preamble index, an SS/PBCH index, and a PRACH mask index) to the terminal, and the terminal transmits the PRACH preamble based on the allocated information.

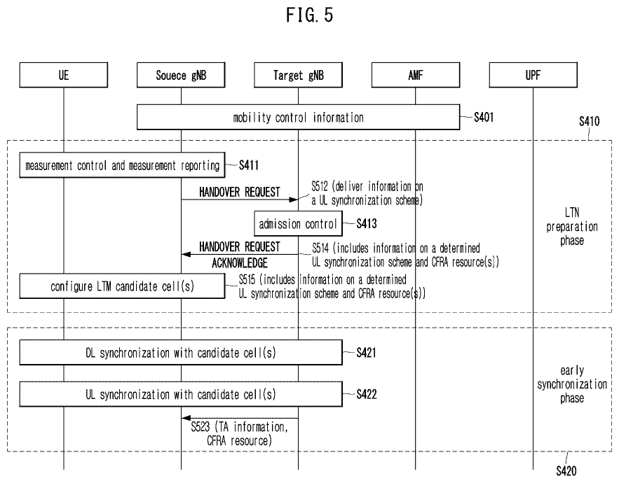

FIG. 5 is a sequence chart illustrating an inter-CU LTM handover method according to another exemplary embodiment of the present disclosure.

The sequence chart illustrated in FIG. 5 is intended to described an inter-CU LTM handover method according to another exemplary embodiment of the present disclosure, in which the LTM preparation phase and early synchronization phase shown in FIG. 4A are improved. In the method illustrated in FIG. 5, the same steps as those in the method illustrated in FIG. 4A are identified using the same reference numerals.

Referring to FIG. 5, the source gNB may select whether to perform the UL synchronization scheme involving only the target gNB or the UL synchronization scheme involving both the source gNB and the target gNB during the early synchronization phase. For example, the source gNB may include information on the selected UL synchronization scheme in a handover request (HANDOVER REQUEST) message and transmit it to the target gNB (S512). This message may include an early synchronization request field (S512).

As another method, the target gNB, rather than the source gNB, may select whether to perform the UL synchronization scheme involving only the target gNB or the UL synchronization scheme involving both the source gNB and the target gNB during the early synchronization phase. Alternatively, the target gNB may receive information on the UL synchronization scheme selected by the source gNB from the source gNB but may independently determine the UL synchronization scheme.

The target gNB may determine the PRACH resource, PRACH parameters, and PRACH preamble (i.e., random access preamble index, SS/PBCH index, PRACH mask index) used in the CFRA procedure. Information on the determined UL synchronization scheme and the determined PRACH resource and related information may be included in a handover request acknowledgment (HANDOVER REQUEST ACKNOWLEDGE) message and transmitted to the source gNB (S514). This message may include information on the PRACH resource, PRACH parameters, and PRACH preamble in form of an RRC container. This message may be transmitted including an early synchronization response field (S514).

After receiving the information for the CFRA procedure (i.e. information on the PRACH resource, PRACH parameters, and PRACH preamble) and the information on the determined UL synchronization scheme, the source gNB may transmit the received information for the CFRA procedure and the information on the determined UL synchronization scheme to the terminal (S515). Specifically, in step S515, the source gNB may transmit the information for the CFRA procedure and the information on the determined UL synchronization scheme to the terminal using the RRC reconfiguration message for configuring LTM candidate cell(s).

After receiving the information for the CFRA procedure and the information on the determined UL synchronization scheme from the serving cell, the terminal may transmit a PRACH preamble to the target cell based on the received information when requested to transmit the PRACH preamble through a PDCCH from the serving cell. Based on the PRACH preamble transmitted by the terminal, the target cell may measure a TA value. The target gNB may transmit the measured TA value to the source gNB through a signaling message (S523). The target gNB may transmit the signaling message to the source gNB after the uplink synchronization is completed, and the signaling message may be transmitted to the source gNB before the source gNB transmits an LTM cell switch command MAC CE to the terminal (S432).

The signaling message may reuse the handover request acknowledgment (HANDOVER REQUEST ACKNOWLEDGE) message transmitted after the uplink synchronization or may use a newly-defined message such as a ‘TA INFORMATION TRANSFER’ message.

The terminal may utilize the TA value received through the cell switch command MAC CE from the source cell when accessing the target cell. Specifically, in the LTM cell switch execution phase and the LTM cell switch completion phase, the terminal may adjust a timing of a UL signal transmitted to the target cell using the received TA value.

In the LTM cell switch execution phase, the terminal may perform a RACH procedure for the target cell (S434). In the RACH procedure, the terminal may access the target cell using a contention-based random access (CBRA) scheme. In the contention-based random access to the target cell, the terminal may perform random access by selecting a PRACH resource and a PRACH preamble based on broadcast-based cell information received from the target cell.

Meanwhile, to use the CFRA scheme, a procedure for the terminal to be allocated a PRACH resource and a PRACH preamble to be used in the target cell needs to be preceded. In the early synchronization phase S420, the target gNB may select the PRACH resource, PRACH parameters, and PRACH preamble to be used in the CFRA procedure and may deliver information on them to the serving gNB by including it in the TA INFORMATION TRANSFER message (S523). Specifically, the TA INFORMATION TRANSFER message may include the random access preamble index, SS/PBCH index, PRACH mask index, TCI state ID, and UL TCI state ID. The serving cell may transmit the information to the terminal (S432), and the terminal may transmit the PRACH preamble to the target cell based on the information (S434).

After the radio section procedure is completed in the inter-CU LTM procedure, an initial wired traffic path may be configured as (UPF-source gNB-target gNB). The source gNB may forward traffic received from the UPF to the target gNB. The wired traffic path may be optimized to configure a path that directly connects the UPF and the target gNB without passing through the source gNB. To achieve this, optimization may be performed by exchanging a path switch request (PATH SWITCH REQUEST) message and a path switch request acknowledgment (PATH SWITCH REQUEST ACKNOWLEDGE) message. The wired traffic path optimization may be applied simultaneously to DL and UL wired paths between the network and the gNB. Alternatively, the wired traffic path optimization may be applied independently to the DL or UL path.

When the inter-CU LTM procedure is performed for a cell group composed of multiple LTM candidate cells, the wired traffic path optimization may not be performed immediately. For example, after the first inter-CU LTM procedure is completed, the initial wired path may be maintained as (UPF-gNB A-gNB B). Here, the gNB A may be the source gNB, and the gNB B may be the target gNB. Subsequently, when the second inter-CU LTM procedure is performed, the wired path may be extended to (UPF-gNB A-gNB B-gNB C). In this case, the gNB B may be the source gNB, and the gNB C may be the target gNB. When the inter-CU LTM procedure is performed multiple times in the above-described manner, the wired traffic path may be gradually extended. The wired traffic path extension scheme described above may have the advantage of utilizing only Xn interfaces without the involvement of the AMF/UPF.

As the inter-CU LTM procedures are performed sequentially, mobility returning to the same gNB in the wired traffic path may occur. In this case, redundant wired paths may be removed to optimize the path. For example, in a situation where the wired traffic path is configured as (UPF-gNB A-gNB B-gNB C), the gNB B may be added again due to a new inter-CU LTM procedure. If the wired path is configured as (gNB B-gNB C-gNB B), an inefficient structure may occur where the gNB B receives data it transmitted again. To prevent this, unnecessary paths may be removed during the data forwarding process to reconfigure the wired path as (UPF-gNB A-gNB B). In this optimization process, a procedure to release the unused path (gNB B-gNB C-gNB B) may be performed. Alternatively, a method of maintaining the gNB B as the last node in the wired path during the data forwarding process may be applied.

When the inter-CU LTM procedures are performed sequentially, multiple gNBs may be included in the wired traffic path. In this case, wired path optimization utilizing the Xn interfaces without the involvement of the network (AMF/UPF) may be performed. For example, a case where the wired traffic path is configured as (UPF-gNB A-gNB B-gNB C) may be considered. In this case, the gNB A connected to the network may be configured as an anchor gNB, and the wired path may be optimized through the Xn interfaces while maintaining the anchor gNB. That is, the gNB B may be excluded from the wired path to optimize the path as (UPF-gNB A-gNB C). In this process, signaling message exchange or path reconfiguration procedures with the network (AMF/UPF) are not necessary. Therefore, this method may be utilized as an Xn interface-based wired traffic path optimization method.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
transmitting a measurement report to a serving cell corresponding to an identifier associated with a first centralized unit (CU);
receiving information on at least one candidate cell including an identifier associated with a second CU from the serving cell through a radio resource control (RRC) reconfiguration message;
transmitting a measurement report on the at least one candidate cell to the serving cell;
receiving a cell switching command medium access control (MAC) control element (CE) for a target cell among the at least one candidate cell from the serving cell;
performing a random access procedure for the target cell based on the cell switching command MAC CE; and
completing a connection to the target cell.

2. The method according to claim 1, wherein when the identifier associated with the first CU is different from the identifier associated with the second CU, a packet data convergence protocol (PDCP) and/or radio link control (RLC) layer is initialized during a process of moving to the target cell.

3. The method according to claim 1, wherein the cell switching command MAC CE includes information on a physical random access channel (PRACH) resource and a PRACH preamble of the target cell, and the random access procedure is performed using the PRACH resource and the PRACH preamble.

4. The method according to claim 1, wherein the cell switching command MAC CE includes a transmission configuration indication (TCI) state identifier (ID) and/or an uplink (UL) TCI state ID for the target cell.

5. A method of a first centralized unit (CU) operating a serving cell, comprising:
receiving a measurement report from a terminal;
transmitting a candidate cell information request to a second CU;
receiving a candidate cell information response from the second CU;
transmitting information on at least one candidate cell including an identifier associated with the second CU to the terminal;
receiving a measurement report on the at least one candidate cell; and
transmitting a cell switching command medium access control (MAC) control element (CE) for a target cell among the at least one candidate cell to the terminal,
wherein the second CU receives a signal transmitted by the terminal to the target cell.

6. The method according to claim 5, wherein the candidate cell information request uses a HANDOVER REQUEST message, and the candidate cell information response uses a HANDOVER REQUEST ACKNOWLEDGE message.

7. The method according to claim 6, further comprising, after the receiving of the candidate cell information response,
transmitting a candidate cell information change request to the second CU; and
receiving a candidate cell information change response from the second CU.

8. The method according to claim 7, wherein the candidate cell information change request is transmitted using a first message, and the candidate cell information change response is received using a second message.

9. The method according to claim 5, further comprising: after the transmitting of the information on the at least one candidate cell to the terminal, receiving time advance (TA) information from the second CU,
wherein the cell switching command MAC CE includes the TA information.

10. The method according to claim 9, wherein in the receiving of the TA information from the second CU, the TA information is received from the second CU using a TA INFORMATION TRANSFER message.

11. The method according to claim 9, wherein in the transmitting of the candidate cell information request, an early synchronization information request is additionally transmitted to the second CU, and in the receiving of the candidate cell information response, early synchronization configuration information for candidate cell(s) is additionally received from the second CU.

12. The method according to claim 11, wherein the early synchronization configuration information includes information on a physical random access channel (PRACH) resource and a PRACH preamble for each of the candidate cell(s).

13. The method according to claim 12, wherein the PRACH resource is indicated by a synchronization signal block/physical broadcast channel (SS/PBCH) block index and a PRACH mask index, and the PRACH preamble is indicated by a random access preamble index.

14. The method according to claim 11, wherein the early synchronization configuration information includes a transmission configuration indication (TCI) state identifier (ID) and/or an uplink (UL) TCI state ID for each of the candidate cell(s).

15. The method according to claim 9, wherein information on a PRACH resource and a PRACH preamble of the target cell is additionally received in the receiving of the TA information from the second CU, and the terminal receives the information on the PRACH resource and the PRACH preamble of the target cell through the cell switching command MAC CE, or receives the information on the PRACH resource and the PRACH preamble of the target cell directly from the target cell by being connected to the target cell.

16. The method according to claim 15, wherein the PRACH resource is indicated by a SS/PBCH block index and a PRACH mask index, and the PRACH preamble is indicated by a random access preamble index.

17. The method according to claim 15, wherein the cell switching command MAC CE includes a TCI state ID and/or a UL TCI state ID for the target cell.

18. The method according to claim 5, further comprising: receiving a HANDOVER SUCCESS message from the second CU that has received a signal transmitted by the terminal to the target cell.

19. The method according to claim 5, wherein the second CU, which receives the signal transmitted by the terminal to the target cell, transmits a request for switching a wired path to an access and mobility function (AMF) and receives a response to the request for switching the wired path from the AMF.

20. The method according to claim 19, wherein the second CU transmits a PATH SWITCH REQUEST message as the request for switching the wired path, and receives a PATH SWITCH REQUEST ACKNOWLEDGE message in response to the request for switching the wired path.
